(19) United States
(12) Patent Application Publication
(10) Pub. No.: US 2003/0221190 A1
(43) Pub. Date: Nov. 27, 2003

(54) System and method for performing patch installation on multiple devices

(75) Inventors: Alka K. Deshpande, Westford, MA (US); Gerald J. Hanam, Framingham, MA (US)

Correspondence Address: LAHIVE & COCKFIELD, 28 STATE STREET, BOSTON, MA, 02109, US

(73) Assignee: Sun Microsystems, Inc., Santa Clara, CA

(21) Appl. No.: 10/222,324

(22) Filed: Aug. 15, 2002

Related U.S. Application Data
(60) Provisional application No. 60/382,648, filed on May 22, 2002.

(51) Int. Cl. G06F 9/44; G06F 9/445; G06F 15/173

(52) U.S. Cl. 717/171; 717/170; 717/176; 709/223

(57) ABSTRACT

A system and method of simultaneously installing a software patch or patches on multiple electronic devices is disclosed. The illustrative embodiment of the present invention provides a method of simultaneously installing a software patch on multiple electronic devices. The user selects the target devices upon which to install a patch or patches. One of the target devices is selected as a “reference device”. The other target devices are validated against the reference device to ensure uniformity of attributes prior to attempting the patch installation. The validation process compares the architecture, operating system (OS) and target application attribute of the target devices to those on the reference device. After the reference device has been validated, patch dependencies on the reference device are programmatically checked to ensure that software required for the patch is present on the reference device (which has the same software found on the other validated devices). The installation of the patch is then performed simultaneously on the validated target devices as a parallel process.

### RELATED AND PRIORITY APPLICATIONS

The illustrative embodiment of the present invention is related to two co-pending applications A System and Method For Performing Patch Installation Via a Graphical User Interface (Attorney Docket Number SMQ-094) and Pre-Verification and Sequencing of Patches (Attorney Docket Number SMQ-096) filed concurrently with the present application. The present application claims priority to a United States provisional application of the same name, serial No. 60/382,648.

### FIELD OF THE INVENTION

The illustrative embodiment of the present invention relates generally to computer systems and more particularly to the performance of simultaneous patch installations on multiple electronic devices.

### BACKGROUND

Software frequently needs to be updated. New technological developments create a need for revisions and changes to existing software in order to maintain interoperability between software components and to enhance the effectiveness of the system utilizing the software. Conventionally the software updates, or “patches”, are installed manually one system at a time The manual installation of a patch requires the system administrator to review numerous installation files in order to validate the target system. The system administrator must ensure that the system architecture, operating systems, and target applications are all the correct version for the intended patch. The user performing the installation must have a proper authorization to perform the procedure. Additionally, the software patch frequently has dependencies of its own which require other additional software to be pre-installed on the target system. The accessibility and the compatability of the additional software must also be verified prior to patch installation. The process of checking dependencies and validating the system is both time intensive and prone to errors due to the inter-dependent nature of the software components residing on the system being checked.

### BRIEF SUMMARY OF THE INVENTION

The illustrative embodiment of the present invention provides a mechanism for simultaneously installing a patch or patches on multiple electronic devices. Utilizing a single software wizard, a system administrator or other authorized user interfaced with multiple electronic devices may simultaneously perform the installation of a patch or patches on multiple devices. The software programmatically validates the target devices for suitability for the patch installation. Additionally, the Wizard pre-verifies the patch dependencies (pre-installed software) required by the patch and checks a target reference device to ensure the target reference device possesses the requisite dependencies. Once the target devices have been validated and the required dependencies identified on the target reference device, the patch installation procedure is performed in parallel on a group of target devices.

In one embodiment, a plurality of electronic devices are interfaced with a network. The devices each have a target application. A location accessible over the network holds at least one software patch for target application(s) which is/are an update for the target application(s). The software patch or patches is/are simultaneously installed on at least two of the electronic devices as a parallel process.

In another embodiment, a plurality of electronic devices are interfaced with a network. The devices each have a target application. A location accessible over the network holds at least one software patch for target application(s), which is/are an update for the target application(s). A software module is used by a user to select two of the electronic devices to receive at least one software patch. One of the selected electronic devices is designated as a “reference” device. The other devices are then validated by comparison to the reference device to ensure that all of the devices have the same OS level, patch level, architecture, and server code. The software patch is simultaneously installed on at least two of the electronic devices as a parallel process.

### BRIEF DESCRIPTION OF THE DRAWINGS

FIG. 1 is a block diagram of an environment suitable for performing the illustrative embodiment of the present invention;

FIG. 2 is a flow chart of the sequence of steps followed by the illustrative embodiment of the present invention to validate devices and verify patch dependencies;

FIG. 3A is a block diagram of the GUI requesting the user to specify the source of the patch file;

FIG. 3B is a block diagram of the GUI requesting the user to select the patch file to be added to the target device;

FIG. 4 is a flow chart of the sequence of steps followed by the illustrative embodiment of the present invention to verify the authority of a user to perform patch installation on multiple machines;

FIG. 5 is a flow chart of the sequence of steps followed by the illustrative embodiment of the present invention to retrieve attributes from the target devices;

FIG. 6 is a flow chart of the sequence of steps followed by the illustrative embodiment of the present invention to check patch dependencies.

### DETAILED DESCRIPTION

The illustrative embodiment of the present invention provides a method of simultaneously installing a software patch on multiple electronic devices. The user selects the target devices upon which to install a patch or patches. One of the target devices is selected as a “reference device”. The other target devices are validated against the reference device to ensure uniformity of attributes prior to attempting the patch installation. The validation process compares the architecture, operating system (OS) and target application attribute of the target devices to those on the reference device. After the reference device has been validated, patch dependencies on the reference device are programmatically checked to ensure that software required for the patch is present on the reference device (which has the same software found on the other validated devices). The installation of the patch is then performed simultaneously on the validated target devices as a parallel process.

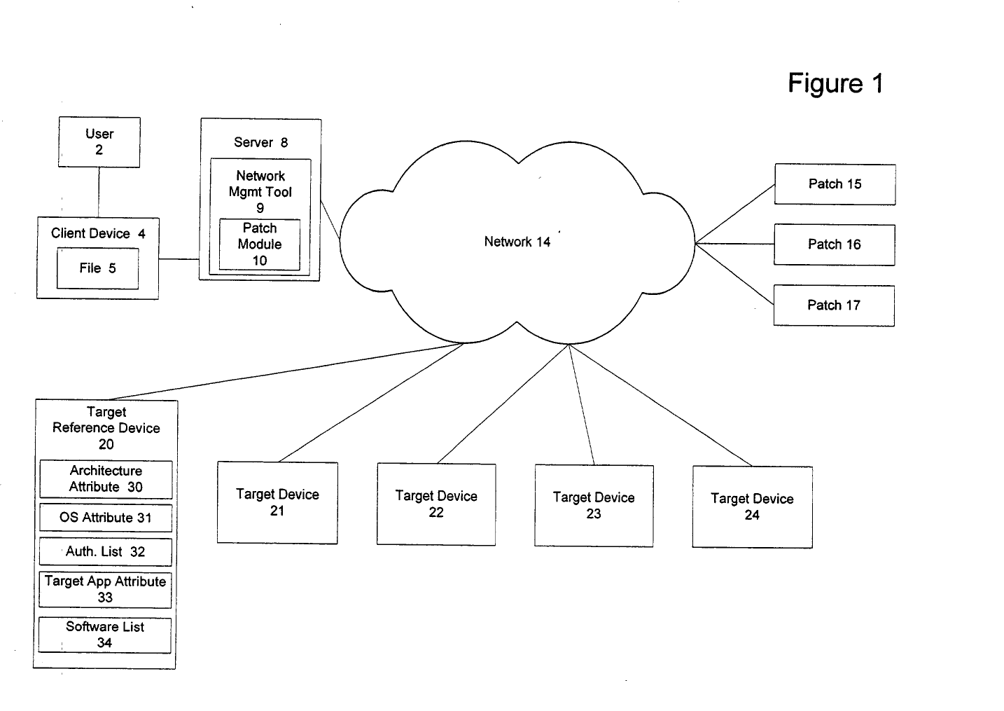

FIG. 1 depicts an environment suitable for practicing the illustrative embodiment of the present invention. A user 2 accesses a client device 4 which is interfaced with a server 8. The client device 4 may be a desktop computer, a workstation, a PDA, network attached device or some other type of electronic device with a microprocessor that is interfaced with the network 14. The client device 4 may include a text file 5 listing target devices for a software patch. The server 8 includes a network management tool 9. The network management tool 9 includes a patch module 10 that is used to install software patches on selected target devices. The server 8 is interfaced with a network 14. The network 14 may be a local area network (LAN), wide area network (WAN), an extranet, an intranet, the Internet, a satellite network or some other type of network. The network 14 is interfaced with a target reference device 20 and a plurality of other target devices 21, 22, 23, and 24. Also accessible over the network 14 are a plurality of patches 15, 16, and 17 which are installed on the target devices 20, 21, 22, 23 and 24 after they have been validated and the target reference device 20 checked for patch dependencies.

The user 2 utilizes the patch module 10 of the network management tool 9 to select a target reference device 20 and other target devices 21, 22, 23, and 24 as possible recipients for software patch updates. The patch module 10 validates the target reference device 20 and the other target devices 21, 22, 23 and 24 as suitable to receive the software patch. The validation process anlayzes a plurality of attributes related to the target device such as an architecture attribute 30, an OS attribute 31 an authorization attribute 32, and a target application attribute 33, collectively, or in some combination. Those skilled in the art will recognize that additional attributes may be utilized without departing from the scope of the present invention. The architecture attribute 30 identifies the architecture attributes of the target device 20, such as whether the device is using a SPARC 64 bit processor or an Intel Tm 32 bit processor. The operating system attribute 31 identifies the operating system and the version of the operating system running on the selected target device. The target application attribute 33 identifies the version of the software that the patch is designed to update. Those skilled in the art will recognize that in certain situations the software patch is designed to update an operating system and accordingly the operating system attribute 31 and the target application attribute 33 will be the same in those cases. Once the target devices 20, 21, 22, 23, and 24 have been validated as suitable for receiving the selected software patch 15, 16 and 17, the patch module 10 can determine the patch dependencies required by the patch selected by the user 2. The software patch 15, 16, and 17 may require other software to be previously installed on a target device prior to installation (i.e.: it may have a patch dependency). The patch module 10 queries the target reference devices 20 to retrieve a software list 34 of the software currently installed on the target reference device. The retrieved list of software 34 is checked to verify that it includes any software required by the selected patch 15, 16 and 17. If the target devices 20, 21, 22, 23 and 24 have been validated and the software patch dependencies have been satisfied, the selected patch is installed on the target devices in parallel by splitting the patch into identical threads and simultaneously installing the patch on each of the target devices.

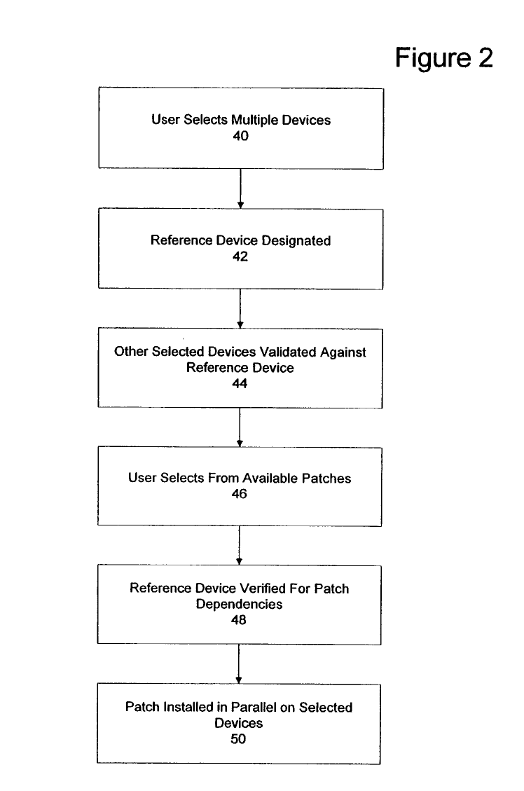

FIG. 2 is a flowchart depicting the sequence of steps followed by the illustrative embodiment of the present invention to validate target devices, determine patch dependencies, and verify that the patch dependencies have been satisfied. The sequence begins when the user 2 selects multiple target devices 20, 21, 22, 23, and 24 to receive a patch installation (step 40). The user 2 may individually select the devices for patch installation via the GUI of the patch module 10, or the user may select a text file 5 containing a list of devices for patch installation. A target reference device 20 is designated either programatically or through user selection from among the target devices 20, 21, 22, 23, and 24 (step 42). The other target devices 21, 22, 23, and 24 are validated against the reference device 20 to ensure that the devices all have the same attributes (step 44). The patch module 10 queries the target devices 20 to retrieve the architecture attribute 30, OS attribute 31 and target application attribute 33. In one embodiment, the patch module 10 utilizes the Common Information Model (CIM) to set up a connection with the target devices. The patch module 10 queries the target devices to ensure a uniformity of attributes. Common Information Model Object Managers (CIMOMs) on the target devices enable access to the target devices 20, 21, 22, 23, and 24 and respond to the query for attributes. In one embodiment, the validation process requires the attributes retrieved from the other target devices 21, 22, 23, and 24 to match exactly the attributes retrieved from the reference target device 20. If the other target devices 21, 22, 23 and 24 match the referenced target device 20, the other target devices are considered to be validated (step 44). In another embodiment, the attributes from the other target devices 21, 22, 23, and 24 must meet or exceed the attributes of the referenced target device 20.

Once the target devices 20, 21, 22, 23, and 24 have been validated (step 44) the user selects a patch or patches for installation (step 46). The target reference device 20 is examined to confirm the presence of required patch dependencies (step 48). If the target reference device 20 satisfies the patch dependencies, the selected patch or patches is replicated into identical threads and installed on the target devices 20, 21, 22, 23, and 24 in parallel (step 50). Because the target devices 20, 21, 22, 23, and 24 all possess the same attributes, the patch dependency check is only required to be performed once.

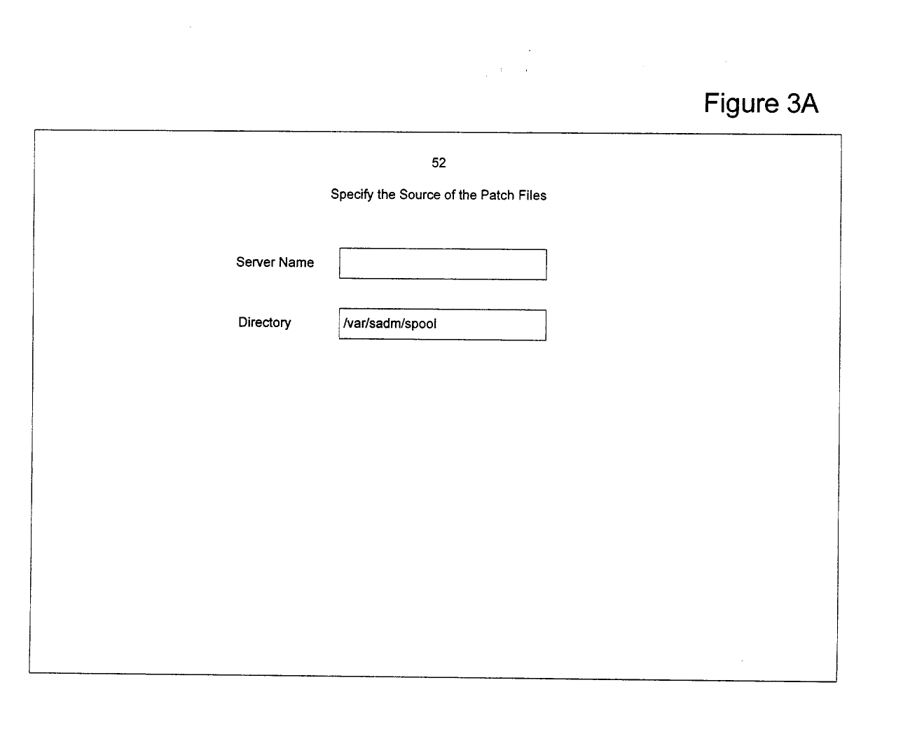

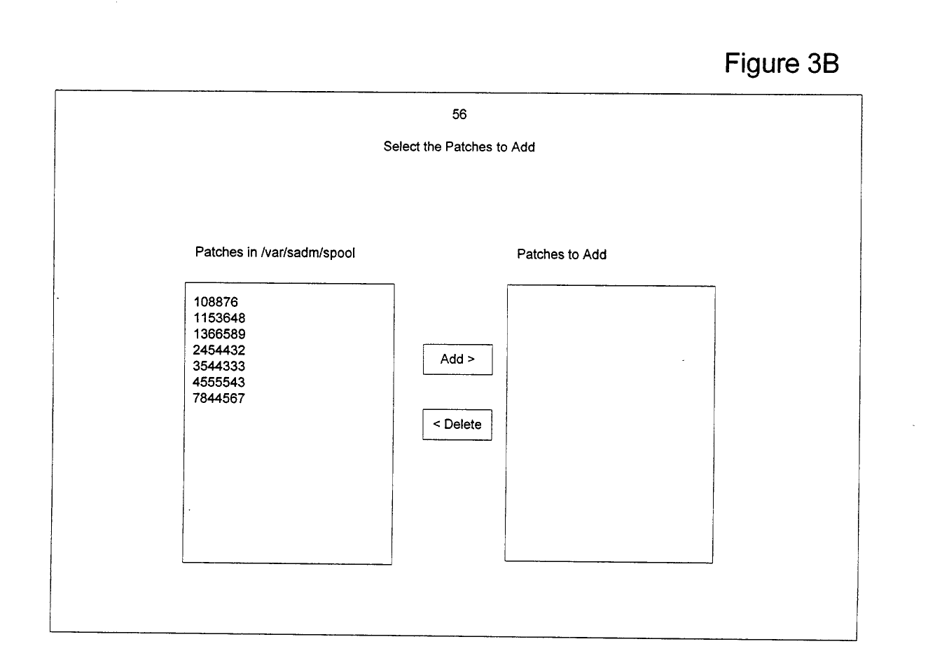

A software wizard enables the user 2 to specify the source of the patch file or files. FIG. 3A depicts a screen display 52 of the software wizard which requests a user 2 to enter the server name and directory holding the patch file or files. FIG. 3B depicts a screen display 56 of the software wizard which lists all of the software patches stored in the location specified by the user 2. The user 2 may select one or more of them and click an add button to finalize the selection. Once selected, each patch is checked for any patch dependency requirements which are then compared with the software installed on the target device 20. Those skilled in the art will recognize that the patches 15, 16 and 17 may be stored at any location accessible over the network. In the event of large scale repetitive installations, the maintenance of an update file 5 or the selection of a pre-defined group of electronic devices provides an efficient mechanism for updating the target devices.

The authority of the user 2 utilizing the patch module 10 to install patches 15, 16 and 17 on selected target devices 20, 21, 22, 23 and 24 must be verified prior to installation. The illustrative embodiment of the present invention provides a mechanism for verifying the authority level of the user attempting to install patches 15, 16, and 17. If the user 2 is not authorized to perform a patch installation on a particular target device, the target device is not added to the installation group.

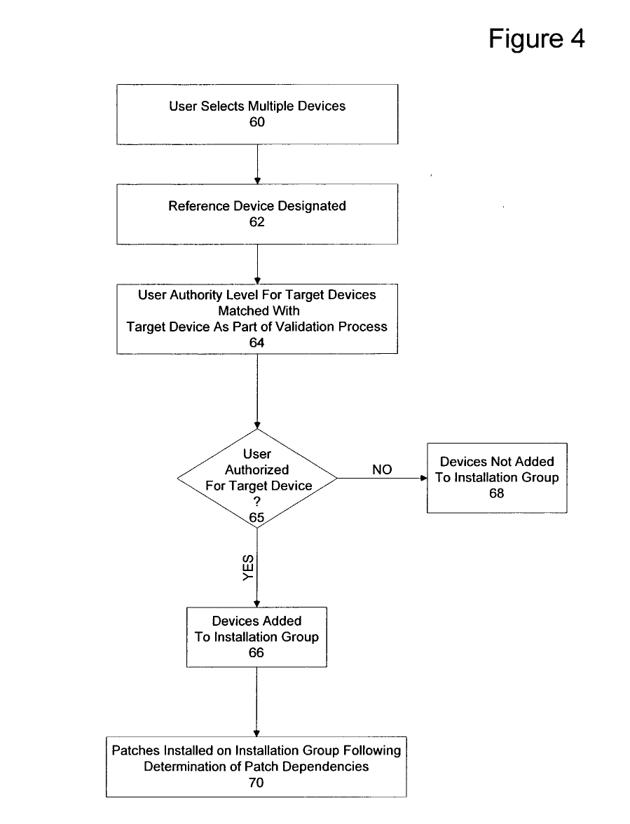

FIG. 4 depicts the sequence of steps followed by the illustrative embodiment of the present invention to verify the authority of the user 2 installing the patches 15, 16, and 17. The sequence begins when the user 2 selects multiple target devices 20, 21, 22, 23, and 24 (step 60). One of the target devices 20 is designated as the reference device (step 62). In one embodiment, the user chooses one of the target devices as the reference device. In another embodiment, the reference device is chosen programmatically. As part of the validation process, the user authority level for the other devices is compared against the target reference device to ensure that the authority level is uniform (step 64). In one embodiment of the present invention, the authority level for the other target devices 21, 22, 23, and 24 must match the required authority level maintained on the target reference device 20. In another embodiment, the authority level on the other target devices 21, 22, 23, and 24 must match or be less than the authority level required for the reference target device 20. The patch module 10 determines the authority level associated with the user 2 and compares it against the authority level required for patch installations on the target reference device 20 (step 65). If the user 2 does not possess the requisite authority level for the reference device, the target devices 20, 21, 22, 23, and 24 are not added to the installation group (step 66). If the user 2 does possess the requisite authority level for the reference device 20, the target devices 20, 21, 22, 23, and 24 are added to the installation group (step 68). The user 2 then selects a patch 15, 16, and 17 to install on the target devices 20, 21, 22, 23, and 24, and the patch module 10 determines the availability of the patches (step 70). The patches are installed on the installation group after the reference device 20 is checked for patch dependencies (step 72).

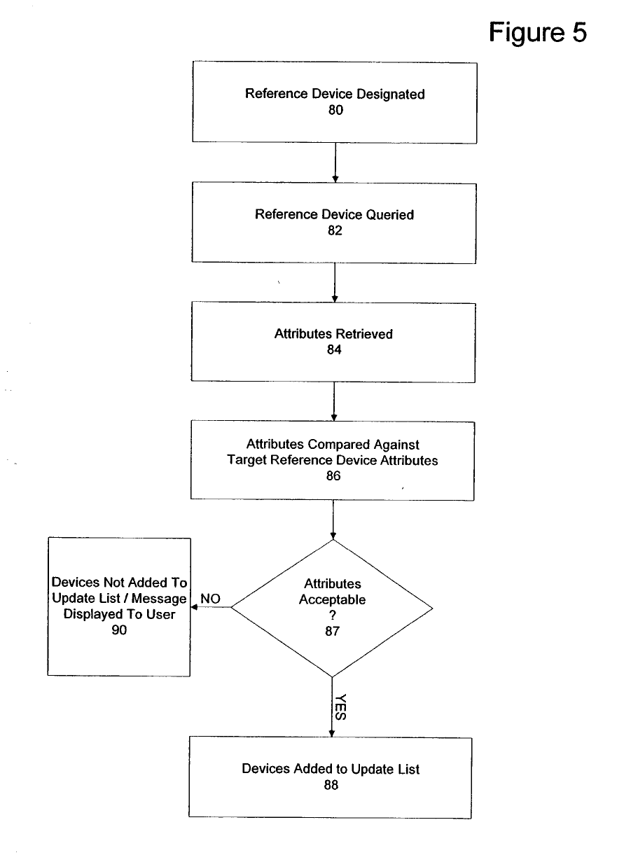

FIG. 5 depicts a flow chart of the sequence of steps followed by the illustrative embodiment of the present invention to validate device attributes prior to performing installation of a software patch. The sequence begins when the user 2 selects multiple target devices. For a patch installation process directed to a small number of devices, the user 2 may indicate each target device individually into the patch module 10 via a dialog box or other method. As the number of devices required to be updated increases however, the user 2 may choose to select the target devices by specifying the name of a file. Alternatively, the user 2 may select the name of a pre-defined group of computers. For example, the user may instruct the patch module 10 to update all of the computers in the purchasing department by specifying “purchasing group”. A reference device from among the target devices is designated (step 80). The patch module 10 queries the target devices 21, 22, 23, and 24 and requests attributes necessary for the installation process (step 82). The attributes are retrieved from the target devices (step 84) and include an architecture attribute 30, an OS attribute 31, and a target application attribute 33. As noted previously, the operating system attribute 31 and target application attribute 33 may be identical in situations where the software the patch is targeted to an operating system. After the attributes are retrieved (step 84), they are compared against the attributes for the target reference device (step 86). If the comparison of the attributes indicates that the attributes of the target devices 21, 22, 23 and 24 are acceptable (step 87), the devices are added to an installation update list (step 88), which is subsequently further checked for software patch dependencies. Alternatively, if the comparison of the attributes reveals that the attributes are not acceptable (step 87), the devices are not added to the update list and an appropriate error message detailing the cause of the validation failure is displayed to the user 2 (step 90).

Many software patches require other software to be installed on a target device prior to the installation of the patch (i.e. the patch has a patch dependency). The illustrative embodiment of the present invention programmatically checks for the presence of patch dependencies for each selected patch and then verifies the satsisfaction of the dependency on the device. Those skilled in the art will recognize that a software dependency for patch may require its own dependency, which in turn requires other dependencies. The patch module 10 checks each generational dependency. Once the reference device 20 is determined to satisfy the required patch dependencies, the patch is replicated as duplicate threads which are then installed simultaneously on the target devices 20, 21, 22, 23 and 24 in the installation group. The patch verification is done only on the reference device 20, the rest of the target devices 21, 22, 23, and 24 receive patch verification automatically since all of the devices in the installation group are the same (they have been validated as the same as explained above) with regards to the patch level.

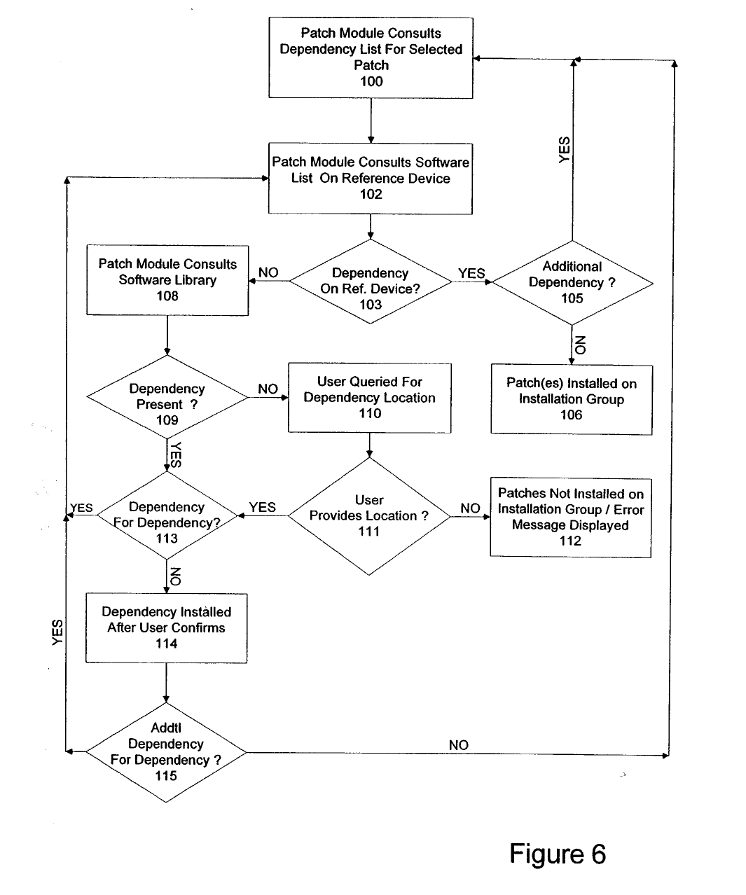

FIG. 6 is a flow chart of the sequence of steps followed by the illustrative embodiment of the present invention to check patch dependencies. The sequence begins when the patch module 10 consults a dependency list for the selected patch (step 100). If there is no dependency associated with the selected patch, the patch module 10 installs the patch on the installation group, otherwise the patch module reviews a software list 34 located on the target reference device 20 (step 102). If the dependency is present in the software list 34 indicating that the software is already installed on the target reference device 20, and there are not additional dependencies required by the software patch (step 105), the patch module installs the patch on the installation group (step 106). If there are additional dependencies, the process iterates and the next dependency is retrieved from the dependency list associated with the selected patch (step 100). If a required dependency is not present on the target reference device 20 (step 103), the patch module consults a software library (step 108) accessible over the network for the dependency. If the dependency is not present in the software library (step 109), the user is queried for the location of the missing dependency (step 110). If the user does not provide the location (step 111), an error message is displayed to the user and the patch is not installed on the installation group (step 112).

If the user does provide the location of the missing dependency (step 111), the patch module 10 determines whether the dependency has any dependencies of its own (step 113). If the dependency has its own dependencies (step 113), the process iterates and the patch module consults the software list on the target reference device 20 (step 102) to determine if the dependency for the dependency is already present on the target reference device and if not, to locate the dependencies. If the dependency does not have its own dependency, the dependency is installed after the user indicates approval (step 114). Those skilled in the art will recognize that the-approval process may be a programmatic process without direct user supervision. After installation of the dependency (step 114), a determination is made as to whether or not there are additional dependencies for dependencies (step 115). If there are additional dependencies for a dependency (step 115), the process iterates and the patch module 10 consults the software list 34 on the target reference device 20. If there are not additional dependencies for a dependency (step 115), the process iterates to make sure all of the original dependencies have been satisfied (step 100). Those skilled in the art will recognize that a selected patch may have more than one listed dependency that is associated with the patch. Furthermore, for each dependency, the dependency may have one or more dependencies. The illustrative embodiment searches generationally and installs the required software (following user approval) recursively from the most remote dependency back to the original dependency that is associated with the selected patch.

In one embodiment, the network management tool 9 which includes the patch module 10 may be split between a client portion stored on the client device 4 and a server portion stored on the server 8. Those skilled in the art will recognize that the client and server portion may be located on the same electronic device. In one embodiment, the network management tool 9 may provide a graphical user interface (GUI) such as those found in the Solaris management console from Sun Microsystems, Inc.

The patch module 10 may include a parameter setting a maximum number of connections at a time that may be utilized by the patch installation process in order to preserve bandwidth on the network 14. Accordingly, installation of a patch to an installation group of target devices numbering more than the parameter takes place in repeated groups of devices equaling the parameter (i.e.: if the parameter is ten, installation to twenty-seven target devices in the installation group takes place in two groups of ten devices followed by the remaining seven devices) In one embodiment, the installation is completed on every device in the group prior to starting a second group. In another embodiment, installation is begun on another device as soon as a connection becomes available.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. In a network having a plurality of interfaced electronic devices, said plurality of electronic devices storing a target application, a method, comprising the steps of:
providing at least one software patch for said target application at a location interfaced with said network, said at least one software patch being an update for a selected application; and
initiating programmatically an installation of said at least one software patch for said target application on at least two of said plurality of electronic devices, said installation occurring in parallel.

2. The method of claim 1, comprising the further step of:
selecting a reference device from said at least two of said plurality of devices, said reference device having at least one of an architecture attribute describing the architecture of said reference device, an operating system attribute describing the type and version of said operating sytem, and a target application attribute describing the version of said target application.

3. The method of claim 2, comprising the further step of:
validating said reference device as suitable for installing said at least one software patch for said target application prior to installing said at least one software patch, said validating comparing at least one of said target application attribute, said operating system attribute, and said architecture attribute to pre-defined parameters.

4. The method of claim 3, comprising the further steps of:
comparing an architecture attribute and said target application attribute from at least one of said plurality of devices which is not said reference device with the architecture attribute and target application attribute of said reference device prior to installing said at least one software patch.

5. The method of claim 4, comprising the further step of:
matching said target application attribute and said architecture attribute from said at least one of said plurality of devices which is not said reference device with the architecture attribute and target application attribute of said reference device prior to installing said at least one software patch.

6. The method of claim 5 wherein a plurality of said electronic devices which are not said reference device are compared to said reference device prior to installing said at least one software patch.

7. The method of claim 1 wherein a user is interfaced with said network and selects at least two of said plurality of electronic devices upon which to install the at least one software patch.

8. The method of claim 7 wherein the authorization level for said user to install said at least one software patch on said plurality of electronic devices is verified prior to installing said at least one software patch.

9. The method of claim 7 wherein said user selects said electronic devices by individually specifying the name of each device.

10. The method of claim 7 wherein said user selects said electronic devices by specifying the name of a file which lists the electronic devices to be updated.

11. The method of claim 7 wherein said user selects said electronic devices to receive said at least one software patch by specifying the name of a pre-defined group of electronic devices.

12. The method of claim 1, comprising the additional steps of:
determining dependencies required by said at least one software patch, said dependencies being installed software required for installation of said at least one software patch; and
querying said plurality of electronic devices to verify that each of said plurality of electronic devices includes said dependencies prior to installing said at least one software patch.

13. In a network having a plurality of interfaced electronic devices, said plurality of electronic devices including at least one target application, a method, comprising the steps of:
providing at least one software patch for said at least one target application at a location accessible over said network, said at least one software patch being an update for a selected application;
receiving a selection from a user interfaced with said network of at least two of said plurality of electronic devices to receive said at least one software patch;
selecting a reference device from said at least two of said plurality of devices, said reference device having at least one of an architecture attribute describing the architecture of said reference device, an operating system attribute describing the type and version of said operating sytem, and a target application attribute describing the version of said target application;
validating said reference device as suitable for installing said at least one software patch for said target application prior to installing said at least one software patch, said validating comparing at least one of said target application attribute, said operating system attribute, and said architecture attribute to pre-defined parameters; and
initiating programmatically an installation of said at least one software patch for said target application on said at least two of said plurality of electronic devices, said installing occurring in parallel.

14. The method of claim 13, comprising the further step of:
displaying a list of said validated machines to said user prior to installing said at least one software patch.

15. The method of claim 13, comprising the additional steps of:
determining dependencies required by said at least one software patch, said dependencies being installed software required for installation of said at least one software patch; and
querying said plurality of electronic devices to verify that each of said plurality of electronic devices includes said dependencies prior to installing said at least one software patch.

16. The method of claim 15, comprising the further steps of:
displaying a list to said user of missing dependencies for each of said plurality of electronic devices prior to installing said at least one software patch.

17. The method of claim 16 comprising the further steps of:
retrieving the software for at least one of said missing dependencies; and
installing at least one of said missing dependencies on each of said plurality of electronic devices prior to installing said at least one software patch.

18. The method of claim 17, comprising the further steps of:
determining that at least one of said missing dependencies also is missing a dependency;
retrieving said missing dependency for said at least one missing dependency; and
installing said missing dependency for said at least one missing dependency prior to installing said at least one missing dependency.

19. In a network having a plurality of interfaced electronic devices, said plurality of electronic devices storing a target application, a medium holding computer-executable steps for a method, said method comprising the steps of:
providing at least one software patch for said target application at a location interfaced with said network, said at least one software patch being an update for a selected application; and
initiating programmatically an installation of said at least one software patch for said target application on at least two of said plurality of electronic devices, said installing occurring simultaneously as a parallel process.

20. The medium of claim 19, wherein said method comprises the further steps of:
determining dependencies required by said at least one software patch, said dependencies being installed software required for installation of said at least one software patch; and
querying said plurality of electronic devices to verify that each of said plurality of electronic devices includes said dependencies prior to installing said at least one software patch.
